(19) United States
(12) Patent Application Publication
(10) Pub. No.: US 2020/0300201 A1
(43) Pub. Date: Sep. 24, 2020

(54) Electromagnetic Heat Induction Fuel Line Manifold

(71) Applicant: MS369 Technology LLC, Miami, FL (US)

(72) Inventors: Ragnar Rodriguez, Miami, FL (US); Amado Vazquez, JR., Miami, FL (US)

(21) Appl. No.: 16/392,711

(22) Filed: Apr. 24, 2019

Related U.S. Application Data
(60) Provisional application No. 62/822,694, filed on Mar. 22, 2019.

(51) Int. Cl. F02M 27/04; F02M 31/125; F02M 37/00; F02B 51/04; H05B 6/06; H05B 6/10

(52) U.S. Cl. CPC F02M 27/04; F02M 31/125; H05B 6/108; F02B 51/04; H05B 6/06; F02M 37/0017

(57) ABSTRACT

The electromagnetic heat induction manifold (EHIM) is disposed in the fuel line of a diesel or gas fueled engine. Fuel flows through a steel tube wrapped by a 15 turn Cu winding and intermediate insulation. The EHIM generates a magnetic field and induces heat by induction which alters the hydrocarbon bonds in the fuel supplied to said diesel or gas fueled engine. The Cu coil is powered by an induction heating control board or module with a regulated output of 1000 to 1800 watts. The EHIM is covered by an aluminum tube. Male and female threads on the steel tube attach the manifold to the fuel line. A magnetic field causes induction heating of the steel and Cu and fuel flowing through the manifold, the field and induction heater region alters the fuel's characteristics in terms of forces that hold the hydrocarbons together.

This is a regular patent application based upon and claiming the benefit of provisional patent application Ser. No. 62/822,694, filed Mar. 22, 2019, now pending, the contents of which is incorporated herein by reference thereto.

The present invention relates to a manifold placed in the fuel line of a diesel or a gas-fed combustion engine which operates as an electromagnetic heat induction fuel line manifold to both ionize the fuel passing there through and to heat the fuel bu induction heating.

### BACKGROUND OF THE INVENTION

Over the years, diesel engines are preferred by manufacturers for their high power output and thermal efficiency as well as lower carbon monoxide (CO) and unburned hydrocarbon (HC) emissions compared to gasoline engines. They are common in buses, heavy-duty trucks and generators. However, the emissions of particulate matter (PM), nitrogen oxides (NOx), sulfur dioxide (SOx), unregulated pollutants such as polycyclic aromatic hydrocarbons (PAHs) carbonyls and halogenated persistent organic pollutants (POPs) from diesel engines are a major concern, since they are toxic to the human health. Several techniques to reduce diesel engine emissions have been suggested, including improving the mechanical design of the engine, but the diesel engine has been developed over the century and the technology has matured. Other techniques include altering the characteristics of the diesel fuels by lowering the lower sulfur content to decrease SOx and adding additives such as alcohols, water containing acetone and dimethyl ethers. Alternative fuels such as biodiesel and biodiesel-diesel blends have as also been considered biodiesel can reduce some of the pollutants like PM, CO, HC and POPs, because of its higher oxygen content, it results in a more complete combustion.

On the other hand, the cost of production, higher viscosity and lower heating value are the main shortcomings of using biodiesel in the diesel engine. Apart from changing the quality of diesel fuel, other methods include application of after-treatment devices such as such as diesel particulate filter (DPF), exhaust gas recirculation (EGR) and selective catalytic reduction (SCR). However, these technologies are not without drawbacks. For example, the DPF may results in PCDD/Fs enhancement (see Heeb et al., 2007; Heeb et al., 2008; Chen et al., 2017), while the EGR may create more incomplete combustion, which lead to increased emission of HC and CO (see Maiboom et al., 2008). The use of SCR has the potential to emit secondary pollutant (see Koebel et al., 2000). Therefore, as a result of shortcomings experienced when using conventional emission control technologies, some researchers have focused their attention and efforts in application of magnetic field in diesel engines to achieve pollutant reduction as well as fuel saving.

Previously, few studies have evaluated the impact of magnetic field on the diesel engine and diesel fuel as well as gasoline engines in terms of pollutant emissions and energy performance (see Govindasamy and Dhandapani, 2007b; El Fatih and Saber, 2010; Faris et al., 2012; Jain and Deshmukh, 2012; Patel et al., 2014; Chaware and Basavaraj, 2015). It is worth noting that while other pollution control devices are placed at post-combustion zones, the devices using magnetic field are applied on the fuel line prior to combustion in most cases. See Patel et al. (2014). Patel has reported 8%, 27.7%, 30% and 9.72% reduction in fuel consumption, NOx, HC and CO2 respectively when using a 2000 gauss magnet on a single cylinder four stroke diesel engine.

Another study used a 5000 gauss magnet and achieved 12%, 22% and 7% reduction in fuel consumption, HC and CO emissions, respectively, but reported 19% and 7% increase in NOx and CO2 respectively. See Ugare et al. (2014). Similarly, a different study applied a range of 2000-9000 gauss magnets and achieved a 9-14% reduction in fuel consumption, which was proportional to magnetic strength, while the reduction of CO and HC were 30 and 40%, respectively, and CO2 increased by up to 10%. See Faris et al. (2012). In this study, a electro magnetic heat induction mahifuld fitted on the fuel line was used to evaluate the impact of magnetic field on the energy performance of a diesel engine in terms of the brake specific fuel consumption (BSFC) and brake thermal efficiency (BTE). See Faris et al. (2012). Additionally, the effects of magnetic field on the emissions of PM, CO, HC, NOx as well as PAHs were also studied.

While most studies place permanent magnet on the fuel line, the inventive manifold uses a electromagnetic heat induction which alters the ionic condition of the fuel and heats the fuel by the application of inductive heat. The fuel passing though a magnetic field alters the hydrocarbon bonds of the fuel.

### OBJECTS OF THE INVENTION

It is an object of the invention to alter hydrocarbon bonds of fuel passing through a magnetically induced heat field and a magnetic field.

It is another object of the invention to increase the fuel efficiency of an internal combustion engine by supplying the engine with treated fuel.

It is a further object of the invention to reduce pollution of an internal combustion engine by supplying the engine with treated fuel.

### SUMMARY OF THE INVENTION

The present invention uses an electromagnetic heat induction manifold in the fuel line of a diesel or gas combustion engine and tests the operational characteristics of the engine during certain driving cycles. A diesel engine with a maximum speed of 2000 rpm was used with the powered manifold.

The manifold is disposed in the fuel line of a diesel or gas fueled engine. An induction controller or module controls the electrical power applied to the manifold. The electromagnetic heat induction manifold includes a single layer wrap or coil of copper tubing or wire over a steel tube through which flows the engine fuel. The single layer wrap coil encased by an aluminum tube. Thermal insulation first covers the steel tube, then covers the single layer of CU tubing or wire, then covers the Cu return line (resulting in three thermal insulating layers). Electrical power is supplied to the cooper wire coil by an induction heating control board module. A magnetic field causes induction heating of the steel and Cu and fuel flowing through the manifold, the field and induction heater region alters the fuel's characteristics in terms of forces that hold the hydrocarbons together.

In more detail, the electromagnetic heat induction manifold includes an elongated cylindrical steel tube, covered by insulation, and wrapped by a 15 turn Cu winding, which is further covered by thermal insulation. These components are disposed in an elongated cylindrical aluminum cover tube. The Cu coil is powered by an induction heating control board or module with a regulated output of 1000 to 1800 watts. Male and female threads on the steel tube attach the manifold to the fuel line.

The invention is also a method of treating a fuel flow supplied to a diesel engine to reduce emissions. The fuel flow is passed through a magnetic field and heating the fuel flow with induction heat such that when the diesel engine is at idle, 25% load and 50% load, wherein said magnetic field and heat reduces emissions as follows: particulate matter (PM), carbon monoxide (CO), unburned hydrocarbon (HC) and CO2 emissions were reduced by about 20-33%, 5-11%, 30-65% and 3-4%, respectively.

### BRIEF DESCRIPTION OF THE DRAWINGS

Further objects and advantages of the present invention can be found in the detailed description of the embodiments, when taken in conjunction with the accompanying drawings, charts, graphs and tables.

FIG. 1 diagrammatically illustrates a system diagram for the manifold disposed or placed in the fuel line leading to the diesel or gas fueled combustion engine.

FIG. 2 diagrammatically illustrates the manifold.

FIG. 3 is a circuit diagram of the induction control board. Other circuits conforming to the specifications set forth herein can be used.

FIGS. 4A and 4B show the impact of electromagnetic heat induction on PAH emissions in terms of total PAH mass concentrations and total BaPeq concentrations (toxicity concentrations).

FIG. 5 shows the congener profiles for PAHs at different conditions of with and without electromagnetic heat induction.

FIG. 6. Shows the variation of brake power for different fuel temperature with engine speed.

FIG. 7 shows the variation of brake thermal efficiency with engine speed.

FIG. 8 shows the effect of different fuel temperatures on brake engine torque for various speeds.

FIG. 9 shows the variation of brake mean effective pressure (BMEP) against engine speed.

FIG. 10 shows the effect of engine speed variation on brake specific fuel consumption (BSFC) for different fuel temperature.

### DETAILED DESCRIPTION OF THE EMBODIMENTS OF THE INVENTION

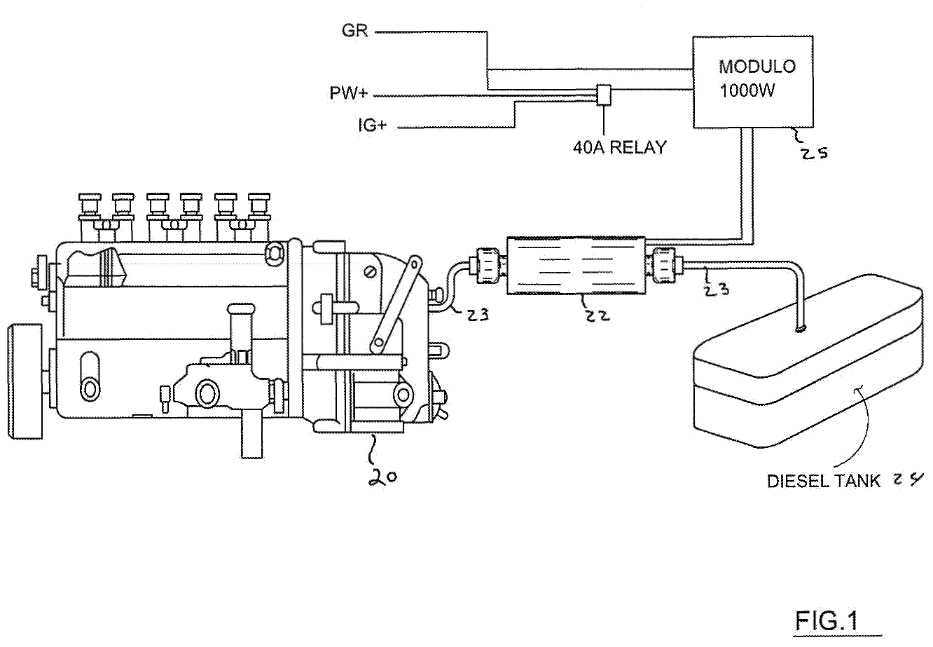

FIG. 1 diagrammatically illustrates a system diagram for the manifold in the fuel line of a diesel or gas fueled engine 20. Engine 20 is fed either diesel or higher octane gasoline from tank 24 via fuel line 23. A control module 25 controls the electrical power applied to the inventive manifold 22. Induction controller 25 is a modulo 1000 w controller having control inputs of IG+, PW+ (fed to a 40 A relay) and a control point GR−. A temperature sensor (not shown) at the output of the manifold 22 interacts with the induction power circuit 25 as a cut off switch as a safety point in case of overheating. Also the temperature sensor reads the temperature of the post-processed fuel. Manifold 25 is about 12 inches from the fuel line intake of engine 20. Sometimes, manifold 22 is in the fuel line before the fuel filter (not shown) and at other times after the fuel filter.

Control circuit 25 measures and regulates the current and voltage supplied to the manifold 22, that is, mainly the power supplied to the inductor coil in the manifold. Control circuit 25 is generally an off-the-shelf controller having the following specifications. Power circuit specifications: 1 KW DC 12-40V ZVS Low Voltage High Frequency 1000 W High Voltage Generator with Coil; 50 A 1 KW ZVS Low Voltage Induction Heating Board High Frequency 1000 W High Voltage Generator. Further specifications include: (a) Input voltage: DC 12V to 40V; (b) Maximum input current: 50 A (short time); (c) Recommended input voltage range: DC 24V to 36V; (d) the power required for heating must be large enough for the coil in the manifold; (e) 12V power supply, current to more than 20 A; and (f) 24V power supply, 36V power supply current is greater than or equal to 30 A; when the current exceeds 50 A.

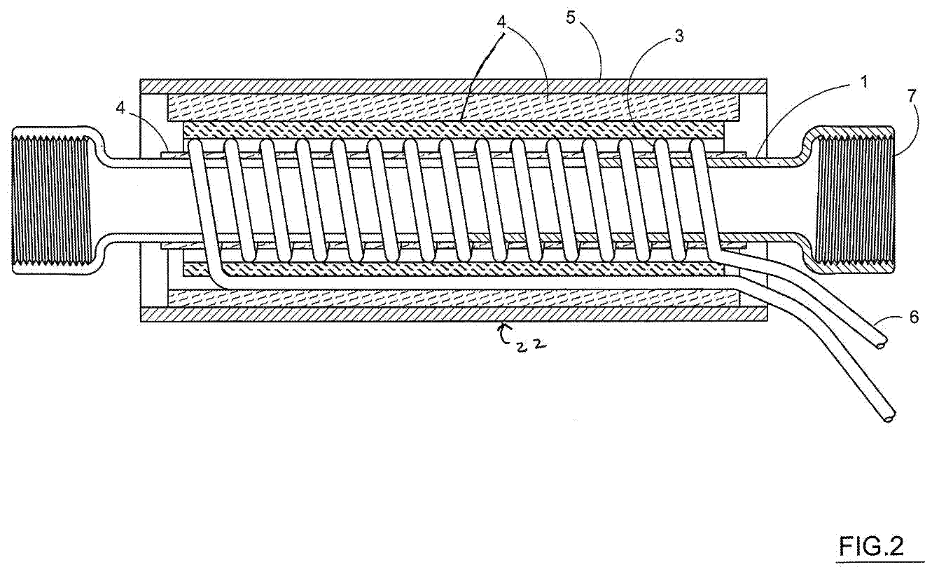

FIG. 2 diagrammatically illustrates the manifold. The electromagnetic heat induction manifold includes a steel tube 1 (an elongated cylindrical steel tube, through which flows the fuel supply to the engine), covered by a first insulation layer 4 (a titanium fiberglass heat wrap), and a 15 turn or winding of a 3 mm copper tubing or wire 3, covered by a second layer of thermal insulation 4 (titanium fiberglass heat wrap 4). The return Cu line is covered by a thrid layer of insulation 4 and the Cu coil is powered by the induction heating board module DC 12V-48V input with a regulated output 1000 to 1800 watt maximum. Induction heat is created by the cooper tube wire 3 wrapped around steel tube 1. Male and female threads on tube 1 attach the manifold to the fuel line 23. The cooper tubing 3 is covered by a 1 inch by 5 inch aluminum cover tube 5. Electrical connectors 6 on the cooper tubing 3 are electrically coupled to the induction control module.

A ⅜ by 5 inch steel tube 1 (a cylindrical hollow steel tube, through which flows the fuel) is first wrapped with a titanium fiberglass heat wrap 4 (a first layer of insulation) to separate the 3 mm copper tubing or wire 3 from the steel tube 1. The copper tubing or wire 3 is wound fifteen times around the ⅜ steel tube 1. A second layer of titanium fiberglass heat wrap is wrapped around the cooper tube or wire. The return line of the copper tube is shown on the left side of the manifold in FIG. 2. A third layer of titanium fiberglass heat wrap is then wrapped around the assembled parts to avoid heat exhaust and to separate the electrical contact from touching the aluminum outer cover 5. An aluminum outer cover 5 (a 1 inch by 5 inch aluminum tube) retains all the components. The ends of steel tube 1 are fitted with ½ inch flared fittings for connection to the fuel line. The ends of the 3 mm copper tubing are connected to the controller which acts as a power source to the induction coils. Temperature is regulated by a heat induction board module DC 12V-48V. A 1000 to 1800 watt power source is used.

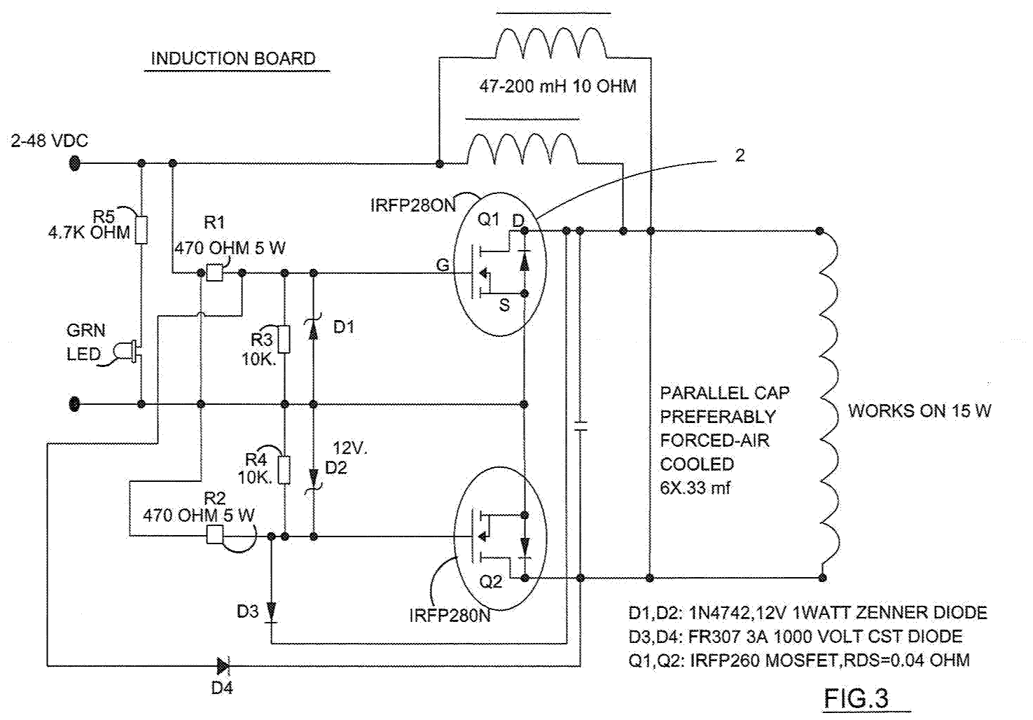

FIG. 3 is a circuit diagram of the induction control board. Other circuits conforming to the specifications set forth herein can be used. The coil is a 47-200 micro henry 10R coil. The transistor Q1 is an IRFP 280N having a based controlled by resister R1 (470 ohms, 5 w) with a diode D4 coupled to another input of the transistor. At the inpute, a 4.7 K ohm resistor R5 feds a green LED light or lamp. The module runs on 12-48v DC power. A second transistor Q2 is an IRFP 280N. Diodes D2 and D3 control voltage and current flows. The base of Q2 is fed a signal via resister R2, a 470 ohm 5 W resistor. Other resistors and diodes are used in the control circuit, A parallel capacitor bank is preferably forced air cooled with 6×0.33 micro farads, which works on a 15 w output. D1, D2 are 1N4742m 12v, 1 w Zener diodes. D3, D4 are FR307, 3 A, 1000v fast diodes. Q1, Q2 are IRFP260N, Mosfets, with Rds of 0.04 ohms.

A magnetic field is applied to fuel flowing through the manifold 22 and the field alters the fuel's iconic characteristics in terms of forces that hold the hydrocarbons together. Tests using the inventive manifold investigated the impact of incorporating a electromagnetic heat induction manifold in the fuel intake line in a diesel engine and, more specifically, the energy performance and pollutant emissions of the combustion engine.

A diesel engine was fitted with the electromagnetic heat induction manifold in the fuel intake line, with an ON/OFF switch. The diesel engine was operated at constant speed of 2000 rpm at idle condition, 25% and 50% loads, respectively. Additionally, two real diesel semi-trucks were outfitted with the electromagnetic heat induction manifold and their fuel consumption computed with the inventive fuel manifold and a second truck without the inventive manifold. The break specific fuel consumption and fuel consumption were decreased by an average of 7.5% and 30%, respectively, while the brake thermal efficiency was improved by approximately 7.5%.

The particulate matter, carbon monoxide, hydrocarbons and carbon dioxide emissions were reduced in the range of 21.9-33.3%, 5.4-11.3%, 29.4-64.7% and 2.68-4.18%, respectively. Both the total PAH concentrations (polycyclic aromatic hydrocarbons (PAH)) and total BaPeq concentrations (benzo[tf]pyrene equivalent (BaPeq) associated with PAHs from gasoline-powered engines) were reduced by about 63%, 45% and 51%, respectively for idle condition, 25% and 50% loads, respectively.

Copper compositions in the cooper tubing maybe: copper alloys (C10200, C10300, C10800, C12000, C12200) that all conform to the chemical composition requirements of alloys containing a minimum of 99.9% Copper (Cu) and a maximum of 0.04% Phosphorous (P). The steel tube 1 can have a steel composition of 0.05%-0.25% carbon and up to 0.4% manganese.

Tests results show that application of electromagnetic heat induction manifold in the diesel engine reduces pollutants and provides fuel efficiency and energy saving.

The manifold was tested by diesel engine runs. The diesel engine was fitted with a electromagnetic heat induction manifold and between experiments, a electrical switch was used to switch the electromagnetic heat induction manifold ON or OFF. The tests on the diesel engine were carried at three (3) different loads at constant speed of 2000 rpm. Each test was run with the electromagnetic heat induction manifold ON and then OFF for an average of 20 minutes. Finally, the sampled fuel gas-volumes were normalized to the condition of 760 mm Hg and 273 K, and denoted as a “Nm3 Impact of Regulated Pollutants” which shows the emissions of the regulated pollutants from the diesel engine. The electromagnetic heat induction was turned ON and OFF for the at idle state and for two loads (25% and 50%). In the presence of an electromagnetic field, the PM, CO, HC and CO2 emissions were reduced by about 21.9-33.3%, 5.4-11.3%, 29.4-64.7% and 2.68-4.18%, respectively. For these pollutants, the highest emissions were registered during idle state due to low combustion efficiency and decreased with increasing engine loads.

On the other hand, the NOx emissions increased by about 1.24-13.4% when the electromagnetic heat induction was used. Additionally, the highest NOx emissions were at higher loads as a result of better combustion achieved at higher loads as the engine performance approaches optimal conditions.

The prior art study of Ugare et al. (2014) using a single cylinder four stroke diesel engine reported reductions in CO (11%) and HC (27%) and an increase in NOx by 19% when they applied 5000 gauss magnet and the Faris et al. (2012) study found out that CO and HC reduced by 30% and 40%, respectively. In the study by Habbo et al. (2011), the HC and CO decreased by 80% and 44% for 1000 gauss magnet and 90% and 58% for 2000 gauss magnet, respectively.

Contrary to these studies, the CO2 increased by 7% (Ugare et al., 2014) and 10% (Faris et al., 2012). The study by Patel et al. (2014) noted 30%, 27% and 9.72% reduction in HC, NOx and CO2, respectively, with respect to the magnetic field.

The reduction of PM, HC, CO and CO2 bby the use of to inventive manifold can be attributed to better combustion efficiency, which is induced by the electromagnetic field that converts para hydrogen into more reactive ortho configuration and weakens the bonds in fuel hydrocarbons making them easy to atomize, mix and react with oxygen in the air. On the other hand, the NOx emission increased with application of magnetic field in the fuel intake.

In the diesel engine, the major NOx source is the thermal NOx, which is controlled by combustion temperatures. Application of magnetic field improves combustion efficiency, which results in higher in cylinder temperatures, which encourage thermal-NOx formation. Impact of electromagnetic heat induction on Total PAH and Total BaPeq concentrations in the exhaust of diesel engine. No study has been located that focuses on the effect of electromagnetic field on organic pollutants such as PAH emissions from the diesel engine.

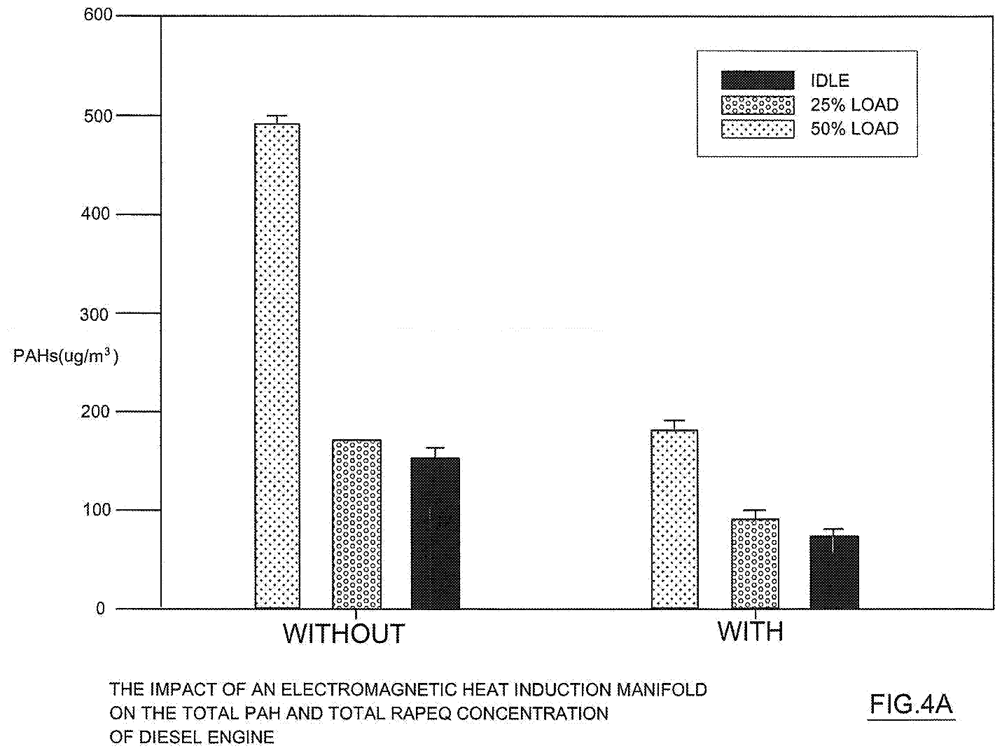

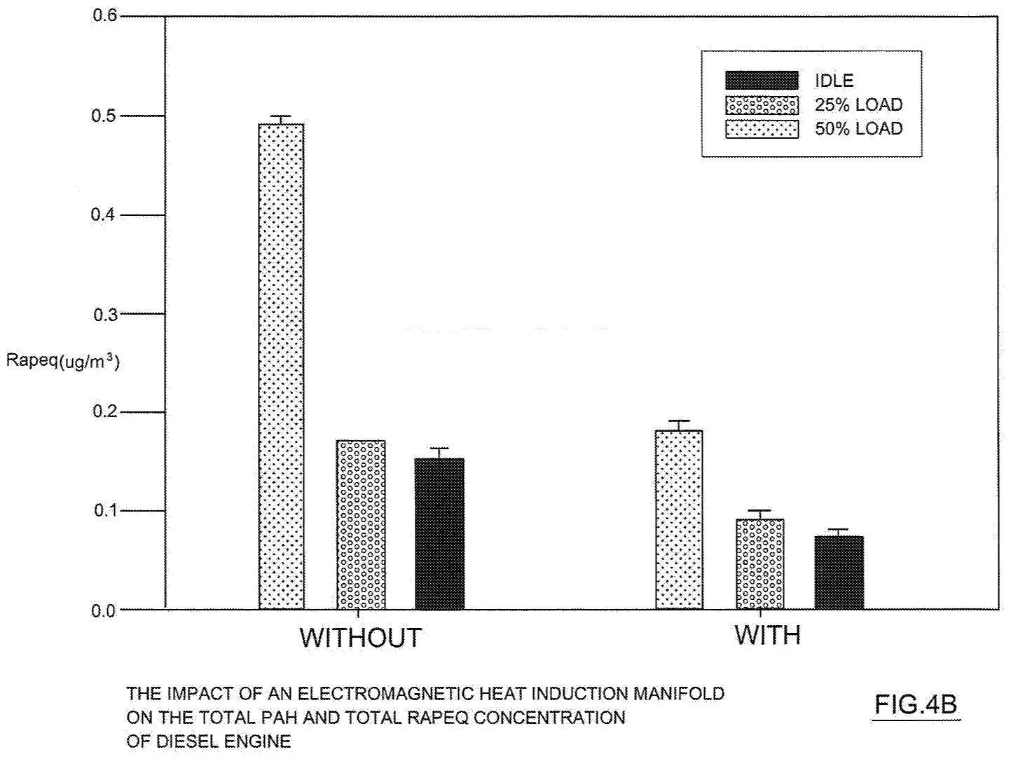

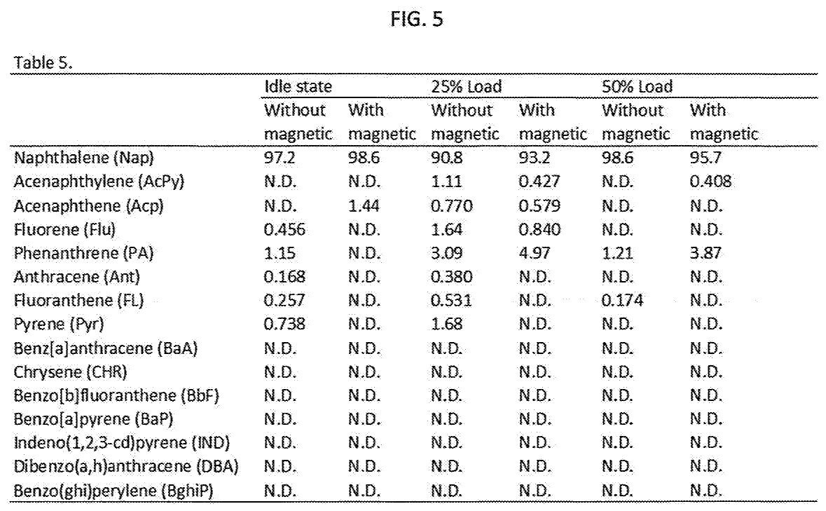

FIGS. 4A and 4B show the impact of electromagnetic heat induction on PAH emissions in terms of total PAH mass concentrations and total BaPeq concentrations (toxicity concentrations). FIG. 5 shows the congener profiles for PAHs at different conditions of with and without electromagnetic heat induction. The electromagnetic heat induction results shown in FIGS. 4A and 4B indicate that, among the different engine loads, the idle state had the highest PAH emissions due to inefficient combustion conditions. The total PAH and total BaPeq concentrations during the idle state were three times higher than at 25% and 50% loads. The total PAH and total BaPeq concentrations are reduced with increased load as the higher loads provided better combustion efficiencies that led to a complete combustion of aromatic and other PAH precursors.

Upon application of magnetic field, the total PAH concentrations were reduced by 62%, 44% and 51% at idle condition, 25% and 50% loads, respectively. Similarly, the total BaPeq concentrations were reduced by 63%, 46% and 51%, respectively. These observations can be attributed to the fact that, when fuel is subjected to magnetic field, which realigns the para hydrogen to more reactive ortho states and weakens the intermolecular forces, allowing better atomization and opens up the hydrocarbons to be more receptive to oxygen resulting in better and more efficient combustion.

Efficient combustion means most of the PAHs in the fuels and PAH precursors are destroyed at high temperatures, leading to decreased PAH emissions. The results shown in FIG. 5 show that Naphthalene (Nap) (90%-97%) was the dominant congener followed by Phenanthrene (PA) (1.1%-5.0%). For both the idles state and 25% load, it is clear that application of magnetic field resulted in formation of more gaseous and low molecular PAHs as the Nap fraction increased slightly when magnetic field was applied. These results infer that the application of magnetic field enhances the destruction of middle molecular weight PAHs such as whose fraction were reduced to ND (non-detectable) in instances.

Engine Operations

Basic parameters are commonly used to characterize engine operations. These include the mechanical output parameters of work, torque and power, the input requirement of air, fuel and combustion; efficiencies; and emission measurement of engine exhaust. Volumetric efficiency is used as an overall measure of the effectiveness of a four stroke cycle engine and its intake and exhaust system as an air pumping device. It is calculated as in Eq. (1): Nu=Mu divided by PaV disp N/2. Where Pa=the inlet air density; Ma=the steady-state flow of air into the engine. Vdisp=displacement volume.

Engine Brake Torque is a good indicator or an engine's ability to work. It is defined as force acting at a moment distance and has units of N-m or lb-ft torque (r) is related to work by Eq. 2: 2rt=Wb=(bmep)Vd/n. Where Wb=brake work of one revolution; Vd=displacement volume; and n=number of revolutions per cycle. For a four-stroke cycle engine that takes two revolutions per cycle, Eq. 3 applies: r=(bmep)Vd/4n.

Brake Power is defined as the rate of work of the engine (Eq. 4). n=number of revolutions per cycle and N=engine speed, then brake is expressed as Eq. (4): W=WN/n; W=2nNr; W=(½n)(mep)ApUp; W=(mep)ApUp/4. Where W=work per cycle; Ap=piston face area of all pistons; and u=average piston speed.

Brake thermal efficiency (Nbth) is the ratio of energy in the brake power (bp), to the input fuel energy in appropriate units. Solving for thermal efficiency as per Eq. 5: Nbth=bp divided by Mass of fuels times calorific value of fuel.

Brake Mass Effective Pressure in the mean effective pressure is a good parameter for comparing engine with regard to desing or output because it is independent of both engine size and speed if brake work is used, brake mean effective pressure is obtained per Eq. 6: Bmep=Wb/Av; and bmep=2rnt/Vd. Where Av=vbdc−vtdc.

Brake Specific Fuel Consumption is when brake power gives the brake specific fuel consumption (Eq. 7): bsfc=m′/Wb. Where m′=rate of fuel flow into the engine.

These factors comprise brake power, brake thermal efficiency, brake engine torque, brake mean effective pressure and brake specific fuel consumption. The trend output for fuel temperature gives the reason for their circumstance.

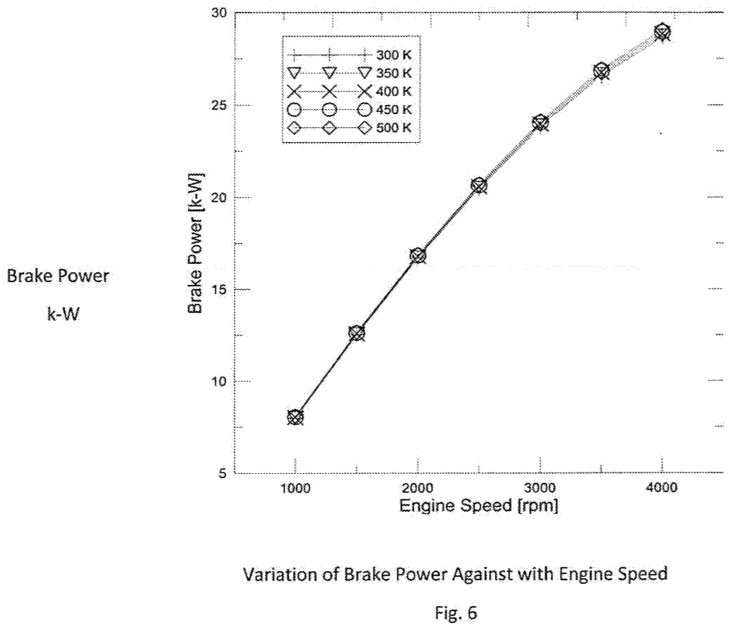

FIG. 6. shows the variation of brake power for different fuel temperature with engine speed. Brake power generally considered when the power absorption device is attached to the drive shaft of the engine. FIG. 6 shows the engine outputs at full load.

Prior art references state that the higher fuel temperatures tend to produce higher in injection pressure. The highest injection pressure causes the lowest ignition delay, thus resulting in the increase of brake power. The shorter ignition delay causes the early start of combustion. A close resemblance occurred at low speed representing small discrepancy in output between the fuel temperatures. The maximum reduction brake power recorded was about 1.39% at the highest speed. It is well known that the heating value of the fuel affects the power of an engine. As the fuel temperature is decreased, the energy level also decreased. Some reduction will occur in the engine power if the lower calorific value of biodiesel used in diesel engine without modification.

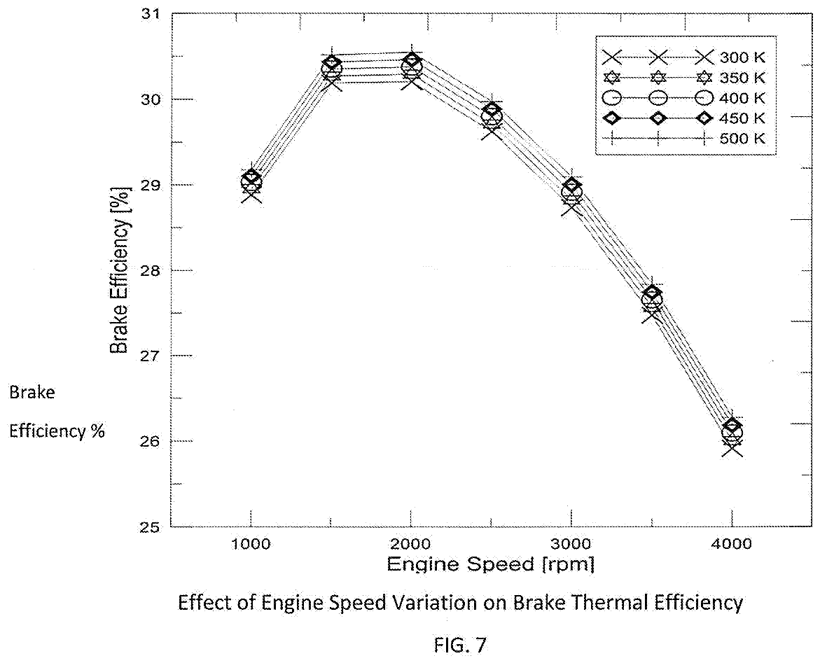

FIG. 7 shows the variation of brake thermal efficiency with engine speed. It is a good measure in assessing how efficiently the energy in the fuel was changed to mechanical output. The graphic generally shows similar trends and closely resemble one another. The brake thermal efficiencies at temperature 300K is lower than temperature at 500K. The lowest temperature caused the energy content decreased thus resulting the lowest of brake thermal efficiency. The efficiency is improved when the fuel temperature increases.

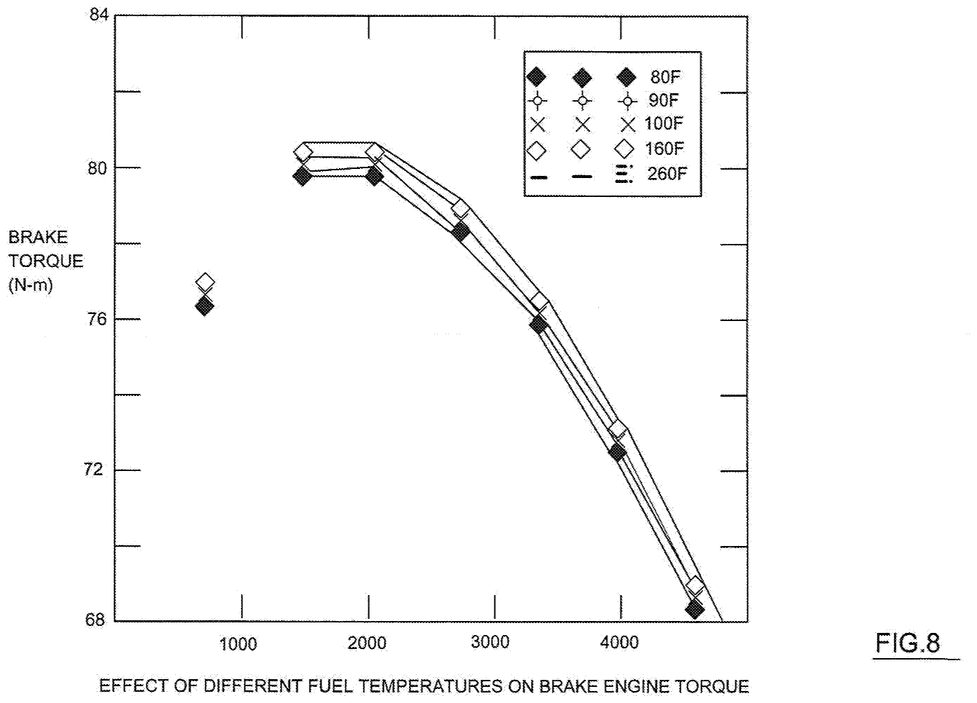

FIG. 8 shows the effect of different fuel temperatures on brake engine torque for various speeds. The torque is a function on engine speed. At low speed, torque increases as the engine speed increase, reaches a maximum and then, as engine speed increase further, torque decreases as shown in FIG. 8. The torque decreases because the engine is unable to ingest a full charge of air at the higher speed. Prior art studies show that higher fuel temperatures tend to produce higher injection pressure. When the fuel temperature is increased, the fuel density decreases. Therefore, a higher injection pressure is required to gain an equal fuel mass in order to produce the same required brake torque. The maximum reduction brake engine torque recorded was 1.13% when engine speed achieved at 2000 rpm.

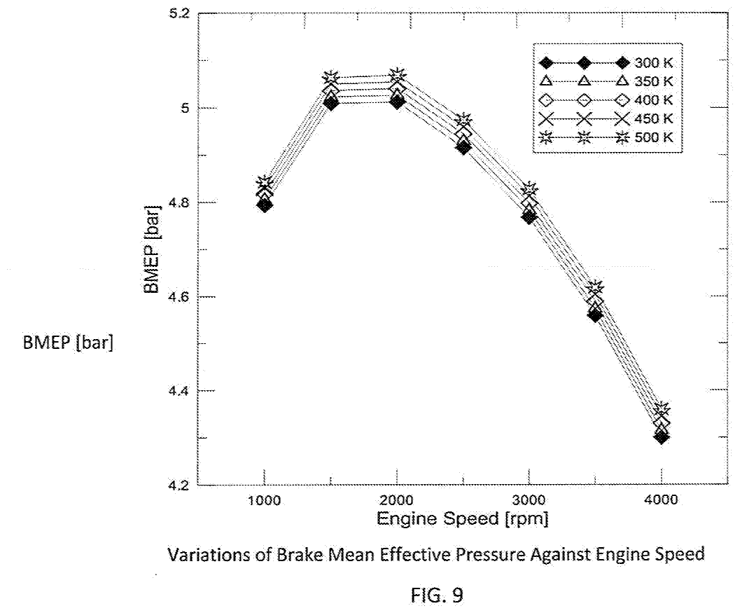

FIG. 9 shows the variation of brake mean effective pressure (BMEP) against engine speed. Brake mean effective pressure is defined as the average mean pressure. When the pistons are uniformly imposed from the top to the bottom of each power stroke, the measured brake power output had generated. FIG. 9 shows the variation of brake mean effective pressure (BMEP) against engine speed. The mean effective pressure is regularly used to calculate the performance of an internal combustion engine. The performance curves generally show the similar trends for each temperature. The maximum reduction of the brake mean effective pressure recorded was about the same with the brake engine torque. Brake thermal, brake torque and (BMEP) show the similar trends with different circumstantial reasons.

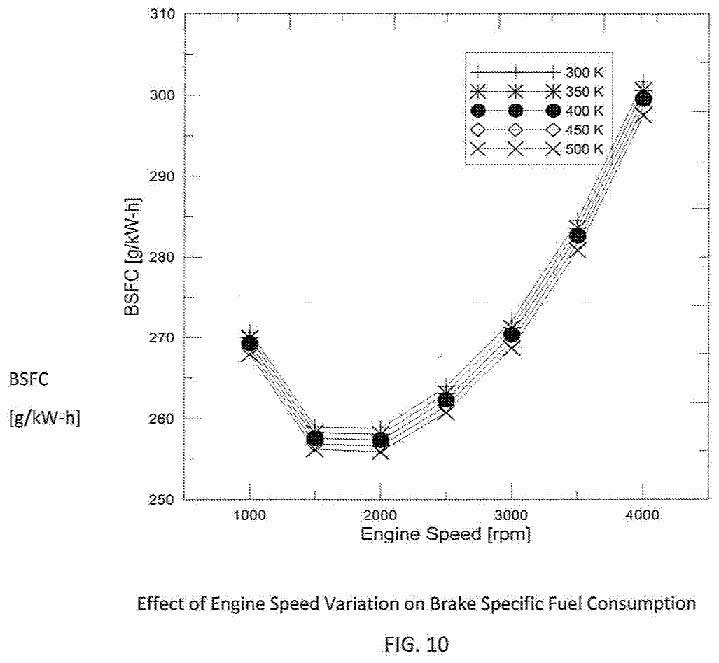

FIG. 10 shows the effect of engine speed variation on brake specific fuel consumption (BSFC) for different fuel temperature. The graph lines generally show similar trends for the of fuels. The minimum (BSFC)(255.907 g/kW-hr) was obtained from highest temperature at 260 F while the maximum (BSFC) (301.668 g/kW-hr) was obtained from lowest temperature at 80 F. The higher (BSFC) is due to lower energy content of the fuel. As the temperature increases, the energy content also increases thus causing the lowest (BSFC) for temperature at 260 F as compared to temperature at 80 F. A prior art study reported that the lowest value of specific fuel consumption obviously desirable.

Using the inventive electromagnetic heat induction manifold in the fuel intake, there was a reduction in BSFC and fuel consumption by an average of 7.5% and 30%, respectively while the BTE was improved by approximately 7.5%. In terms of pollutant control, the PM, CO, HC and CO2 emissions reduced by about 21.9-33.3%, 5.4-11.3%, 29.4-64.7% and 2.68-4.18%, respectively while NOx emissions were increased by about 1.24-13.4%. A magnetic field on PAH emissions shows that in an idle condition, at 25% and 50% loads, both the total PAH and total BaPeq concentrations in the exhaust of diesel engine can be reduced by about 63%, 45% and 51%, respectively. These results show that the use of the electromagnetic heat induction manifold in the diesel engine fuel line saves fuel and reduces pollutant emissions. The effect of fuel temperatures on at various engine speeds and their impact on the engine performance of a four stroke diesel engine is documented by these test results. Further, the results show: the highest fuel temperature causes the highest injection pressure thus resulting in shorter ignition delay. The shorter ignition delay attributed to the early start of combustion thus lead to the higher in-cylinder pressure. The increasing of fuel temperature representing the highest energy content thus resulted in lower BSFC, which is a desired result.

The claims appended hereto are meant to cover modifications and changes within the scope and spirit of the present invention.

What is claimed is:

1. A fuel treatment manifold adapted to be disposed a fuel line suppling fuel to a diesel or gas fueled engine comprising:
an elongated substantially cylindrical steel tube which is adapted to flow said fuel;
a single coil of copper wire or tube insulated from but wrapped around said steel tube;
an induction heating controller electrically coupled to the cooper coil with a regulated output of 1000 to 1800 watts;
said cooper coil and steel tube generating induction heat and a magnetic field adapted to alter said fuel supplied to said diesel or gas fueled engine.

2. The fuel treatment manifold as claimed in claim 1 including a layer of thermal insulation between said steel tube and said copper coil.

3. The fuel treatment manifold as claimed in claim 2 including a further layer of thermal insulation about said copper coil.

4. The fuel treatment manifold as claimed in claim 3 including an aluminum cover over the further layer of thermal insulation, said copper coil and said steel tube.

5. A fuel treatment manifold adapted to be disposed a fuel line suppling fuel to a diesel or gas fueled engine comprising:
a steel tube which is adapted to flow said fuel;
a copper coil laid in a single layer wrapped around said steel tube;
an induction heating controller electrically coupled to said cooper coil having a regulated output of 1000 to 1800 watts;
said cooper coil and steel tube generating a magnetic field and inducing heat by induction which is adapted to alter fuel supplied to said diesel or gas fueled engine.

6. The fuel treatment manifold as claimed in claim 5 including a layer of electrical insulation between said steel tube and said copper coil.

7. The fuel treatment manifold as claimed in claim 6 including one or more layers of thermal insulation about said copper coil and said steel.

8. The fuel treatment manifold as claimed in claim 7 including an aluminum cover over said thermal insulation, said copper coil and said steel tube.

9. The fuel treatment manifold as claimed in claim 5 including a temperature sensor on or about a manifold output which generates a temperature indicator and wherein said controller monitors said temperature indicator to control the heat by induction.

10. The fuel treatment manifold as claimed in claim 5 used in conjunction with a diesel engine at idle, 25% load and 50% load, wherein said magnetic and heat field reduces particulate matter (PM), carbon monoxide (CO), unburned hydrocarbon (HC) and CO2 emissions were reduced by about 20-33%, 5-11%, 30-65% and 3-4%, respectively.

11. The fuel treatment manifold as claimed in claim 1 used in conjunction with a diesel engine at idle, 25% load and 50% load, wherein said magnetic and heat field reduces particulate matter (PM), carbon monoxide (CO), unburned hydrocarbon (HC) and CO2 emissions were reduced by about 20-33%, 5-11%, 30-65% and 3-4%, respectively.

12. A method of treating a fuel flow supplied to a diesel engine to reduce emissions comprising:
passing the fuel flow through a magnetic field and heating the fuel flow with induction heat such that when the diesel engine is at idle, 25% load and 50% load, wherein said magnetic field and heat reduces emissions as follows: particulate matter (PM), carbon monoxide (CO), unburned hydrocarbon (HC) and CO2 emissions were reduced by about 20-33%, 5-11%, 30-65% and 3-4%, respectively.
